(19) United States
(12) Patent Application Publication
(10) Pub. No.: US 2011/0191689 A1
(43) Pub. Date: Aug. 4, 2011

(54) ENHANCED KNOWLEDGE CREATION SYSTEM FOR A SPONTANEOUS ONLINE COMMUNITY

(76) Inventor: Ming Han Chang, Ping Tung (TW)

(21) Appl. No.: 12/764,093

(22) Filed: Apr. 21, 2010

Related U.S. Application Data
(60) Provisional application No. 61/171,018, filed on Apr. 20, 2009.

(51) Int. Cl. G06F 3/048

(52) U.S. Cl. 715/739; 715/738

(57) ABSTRACT

A method of sending notice to a group of users in a cooperative online platform which has a page with a content area and a question and answer area is described. The method provides a first notice method to receive benefit by a first user and a responsibility to answer a second notice by the first user. The second notice is given by the person have contribution in the page. The user question is designated by the person who contributes content in the page to the page and a second notice is sent to the first user.

### CROSS-REFERENCE TO RELATED APPLICATIONS

This application claims the benefit of provisional patent application Ser. No. 61/171,018, filed Apr. 20, 2009 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The application relates to a knowledge creation system for an online community. More particularly, a notice method used in a cooperative platform.

The rapid development of Internet makes it easy for users to find what they want. The online search engine or theme oriented forums are very popular in the Internet. However knowledge obtained from either search results or forum post is sparse and of unstable quality. Other websites like Yahoo Knowledge or Yahoo Answers is another functional website provide knowledge or answer. Each post with questions and answers is not collected by edition. Those posted article are still sparse and users still rely on search engine to find out the knowledge related to their questions. These search engines often answer user queries with large amount of irrelevant knowledge.

Compared those knowledge platforms, the creation of Wikipedia provide not only a structured content for knowledge presentation (like a book) but also a platform for community member to edit article. As the founder of Wikipeida Mr. Jimmy Wale claimed, the website is served “to share and synchronize local and personal knowledge, allowing society's members to achieve diverse, complicated ends through a principle of spontaneous self-organization.”

Currently, so-called web 2.0 platform like Wikipedia or YouTube requires users to voluntarily provide their creations to enrich the content of the platform. It works for years. However such cooperative platforms provide pretty poor notice methods for participants. The interested reader is required to access the web 2.0 platform to know whether there is an updated information or contribution.

### BRIEF SUMMARY OF THE INVENTION

In accordance with one embodiment, a method of sending notice comprises receiving and providing a content, obtaining a user input from a first user to indicate that the first user wants to receive a first notice of a new content in the page and sending the first notice to the first user. The method further comprises obtaining a user question by a second user, wherein the user question is designated by the second user to the page, providing the user question for reviewing in the question and answer area of the page and sending a second notice of the user question to the first user.

### BRIEF DESCRIPTION OF THE DRAWING

FIG. 1 shows an illustration of the participants' role in accordance with one embodiment.

FIG. 2 shows a follower's role in accordance with one embodiment.

FIG. 3 shows a personal space structure in accordance with one embodiment.

FIG. 4 shows a page structure in accordance with one embodiment.

FIG. 5 shows one flowchart operation for notice in accordance with one embodiment.

FIG. 6 shows one example factor used in the flow chart operation for notice.

FIG. 7 shows an illustration of notice for question in one page in accordance with one embodiment.

FIG. 8 shows an illustration of notice for question when Smart Route option is selected.

FIG. 9 shows an illustration of notice for help announcement.

### DETAILED DESCRIPTION OF THE INVENTION

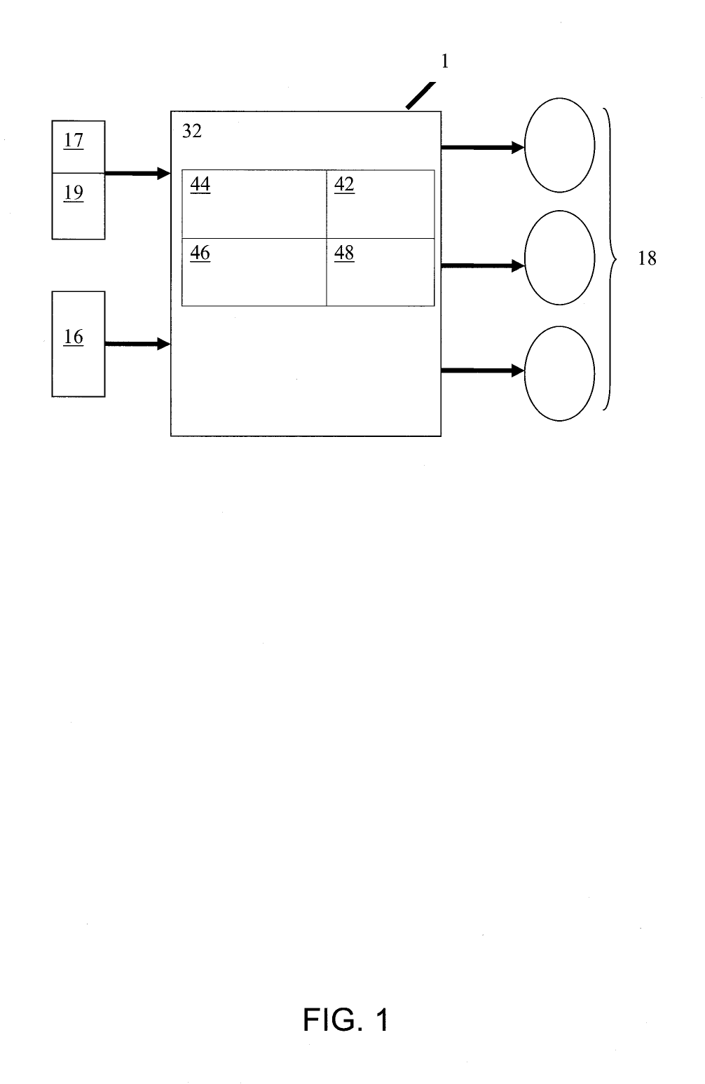

FIG. 1 shows an illustration of participants' interaction with each other in the platform 1. The platform contains at least one page 32. Contributor 17 and editor 9 contribute content or improve the page's appearance in the article area 44, dynamic data area 42 or comments and announcement area 48 in a page 32. Observer 16 reviews the pages 32 and observer 16 asks questions in the question and answer area 46. It should be noted, one user could be a multi-role user. A user could be an editor or contributor or merely an observer in the platform 1. When platform 1 receives a contribution or a question in a page 1, the platform 1 will send notice with appropriate methods to recipients 18. Again, the recipients 18 are one of participants either a contributor 17, an editor or an observer. The content of notice could be categorized in two. First is Sweets. Sweets information benefit recipient 18 for certain degrees. On the other hand, the second notice is delivered to recipient 18 to ask recipient's favors for certain responses. We call it Sweats.

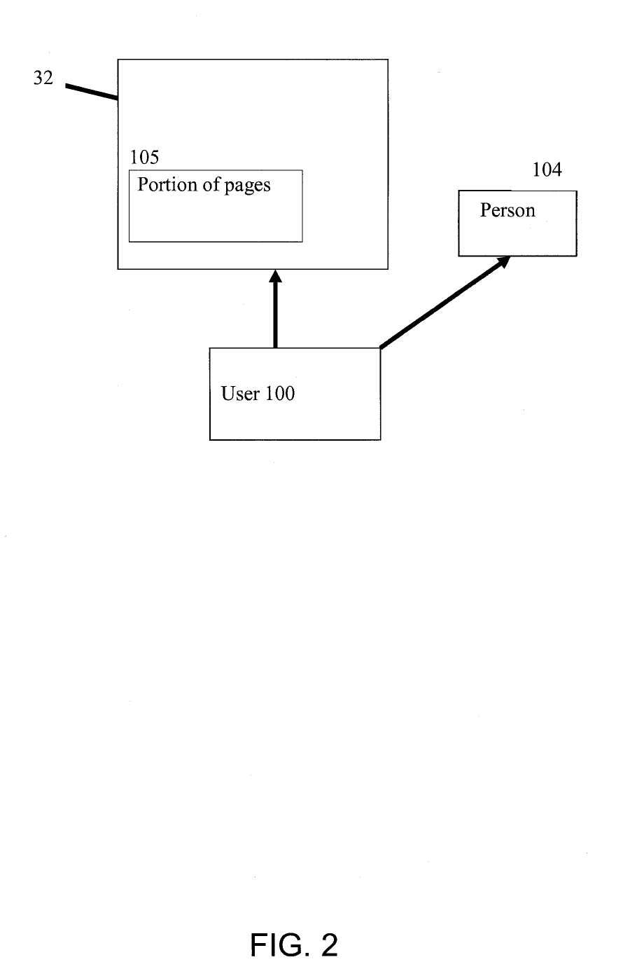

Some people feel others' contribution is extremely useful or/and some pages' information is highly related to their interests. Those people like to become recipients to receive some updated information from either the page 32 or a contributor 17 from time to time. In order to receive such updated information up to time, those recipients must follow the page 32 or an interesting user 104 in FIG. 2. FIG. 2 shows an example where user 100 is willing to receive a participant's (user 104) contributions or creative works as well as said participant's (user 104) question or a help announcement. FIG. 2 shows another example where user 100 is willing to receive a page's (page 32) updated contributions as well as the questions or help announcement provided by the user who generated those updated contribution. In a word, a follower (user 100) adds one user (user 104) or one page (page 32) to enjoy Sweets and to bear Sweats at same time. A follower could follow a portion of a page 105 if that portion is related to said follower's geographical relation like residence or home town or more specifically related to said follower's interests like traffic in south Taipei or earthquake in northern Taiwan.

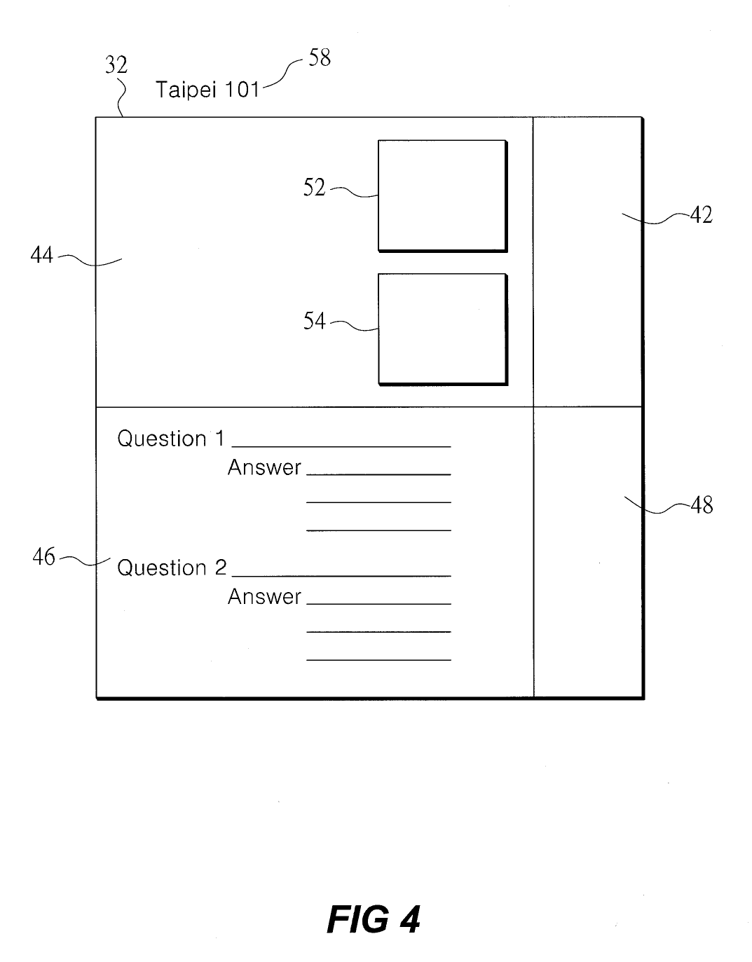

If a page is followed by a follower, the page would send notice to the follower. The page for a cooperative working platform 1 is illustrated in FIG. 4. Here are four main areas—article area 44, question and answer area 46, dynamic data area 42 have information related to the title 58 and comments and announcement area 48. Article area 44 has organized knowledge and may include structured content. It is one example that the appearance of article area 44 could be designed similar to the pages of wikipedia. It should be noted that comments and announcement area 48 contains help announcement and question and answer area 46 contains a participant's question in the page. The qualified participant could post a help announcement or a question. In one embodiment, only participant certainly contributes something to the page is qualified to post a question or a help request. Once the question or the help request is established in the page, at least, a portion of the page's followers will receive a notice of such question or help request.

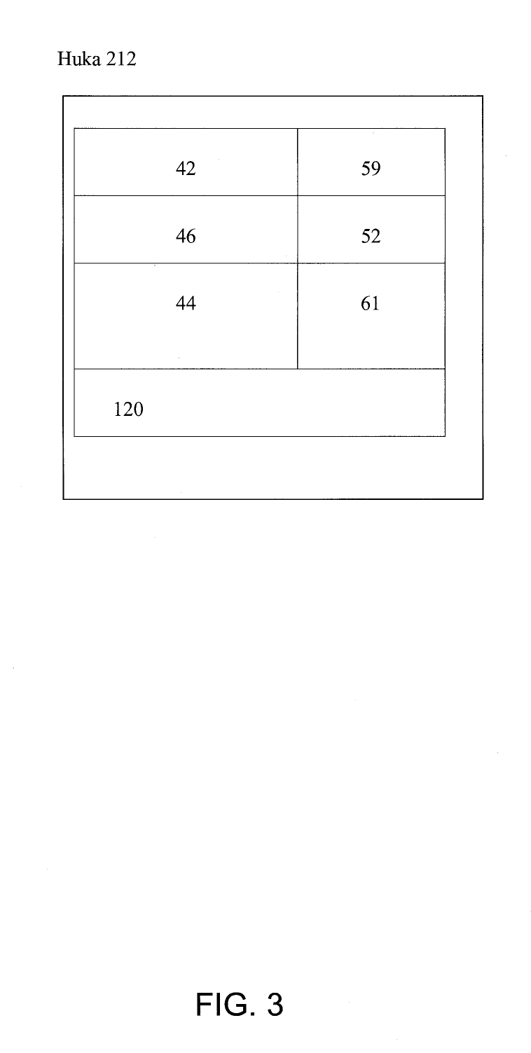

In the case of following an interesting user, FIG. 3 introduces a participant's home space named Huka 212. In the Huka 212, left columns are aggregated works for one participant including but not limited to dynamic data area 42 or a kind of microblogging format, the article area 44, or question and answer area 46 for all pages this participant contributes or makes. Since a history of one's works or contributions are a long list, it is possible to show them in a short format. The right column is a life stream area 59 which may include this participant's other accounts feeds including the feeds from Myspace, Jaiku, a picture areas 52 or a music and sound record area 61. The life stream area 59 and a picture areas 52 or a music and sound record area 61 could be in the microblogging format or purely storage format. The Huka 212 provides a participant a diary tool to review history and also provides others or directory tool (software analysis tool) a way to judge whether the potential follower could rely on (left column—People relied on my works) or whether such participant's life is interesting (right column—People interests in my life). For someone who has privacy concerns, some portions could be hidden from normal users, for example, one's questioning and answering section could be hidden and allow only follower or friend could see at least a portion of the whole article. Friend is the people you follow and follow you.

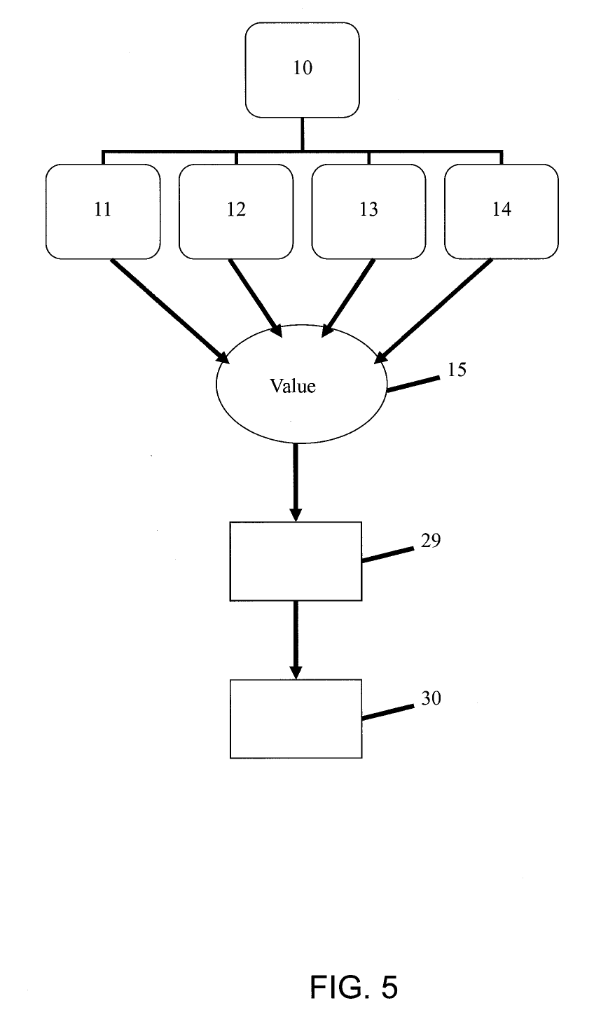

In the case of sending notice, FIG. 5 shows a procedure to spread out information to followers in two basic steps. First is to form a follower list 10. The follower list is established by other's feeling of whether a user or a page is worthy to follow from reviewing one individual's Huka or the page. It is also possible to follow a participant who answers you a satisfied question or provides you a satisfied service. In one embodiment, system will send out notice to those followers either from a page's follower list or a user's follower's list. A user could further select a Smart Notice option. Then the procedure goes on the second step which is a multifactor evaluation, and this evaluation depends on several factors including but not limited to (a) accuracy degrees derived from the contributors' reputation points 11 (b) accumulation depends on the accumulated amount of content of page changed since one's last visit 12; (c) the contribution or the information related to a geographical place based on the distance from the follower's living place or interested place 13; (d) lexical analysis on content of the information and then considering the importance and relevancy of the content. 14. For the lexical analysis on content, the contributor (owner of the works), editor or other user can provide the content with some tags. System also can automatically review it and provide tags. Besides, the original contributor could mark contribution as important for example marking earthquake news important.

The multifactor evaluation produces an evaluation value 15 in FIG. 5. While such value is above a threshold 29, the platform 1 will activate a minimum notice method, for example sending an email notice in the step 30. While the value is greater, more invasive notice method may be employed.

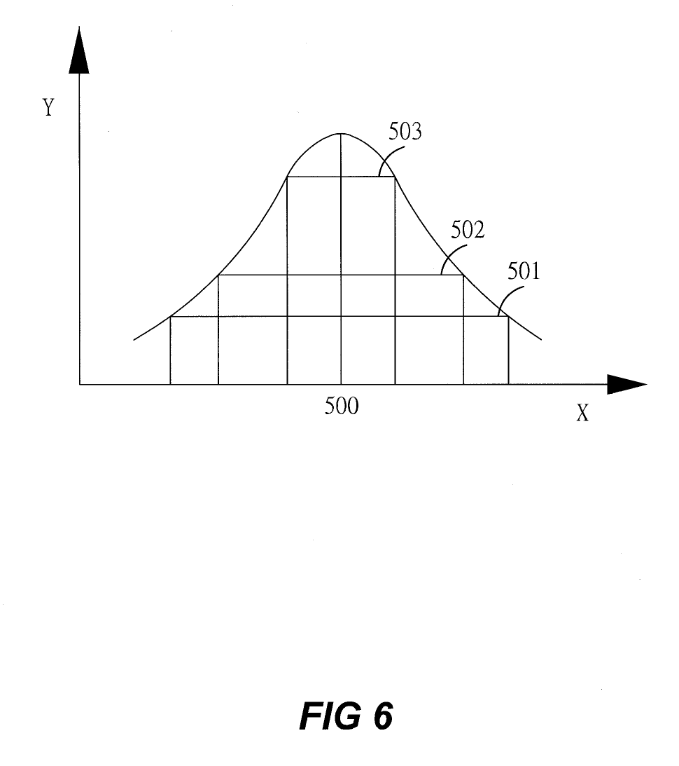

To decide the manner to give notice, taking FIG. 6 as one example, it illustrates the evaluation value generated from only one factor—geographical location diagram. The center of X-axis is the location of one participant's home town 500. The evaluation only concerns the distance between the home town and the place related to a contribution or a news (dynamic data). As shown in the diagram, the more near to the home town location, the evaluation value is greater. In this example, cross line 501 is a threshold to activate a notice. Cross line 502 is to activate an invasive notice for example a short message to your mobile phone with one sound Ding. Cross line 503 is to activate a more invasive notice for example a call to your mobile phone. The way or the methods to send a notice is called a manner to send a notice in this invention. While FIG. 6 has only one factor in X-axis, it is possible to have other evaluation factor like importance level in Z coordination. The importance level will review the content of contribution and find some critical words or tags such as earthquake or traffic. Then the Y-axis could represent an evaluation factor of relevancy. More factors could be employed to generate an evaluation value. For the purpose of sending information for the updated contributions, it should be noted that while we said content of contribution, it should include the meaning of sending any information behind any works or derivations from said work resulted from participants' efforts no matter in the stage of deciding who to follow, in the stage to decide whether to send out said information, in the stage of deciding in which manner to send or in the stage to decide how to divide the groups in a user's follower list.

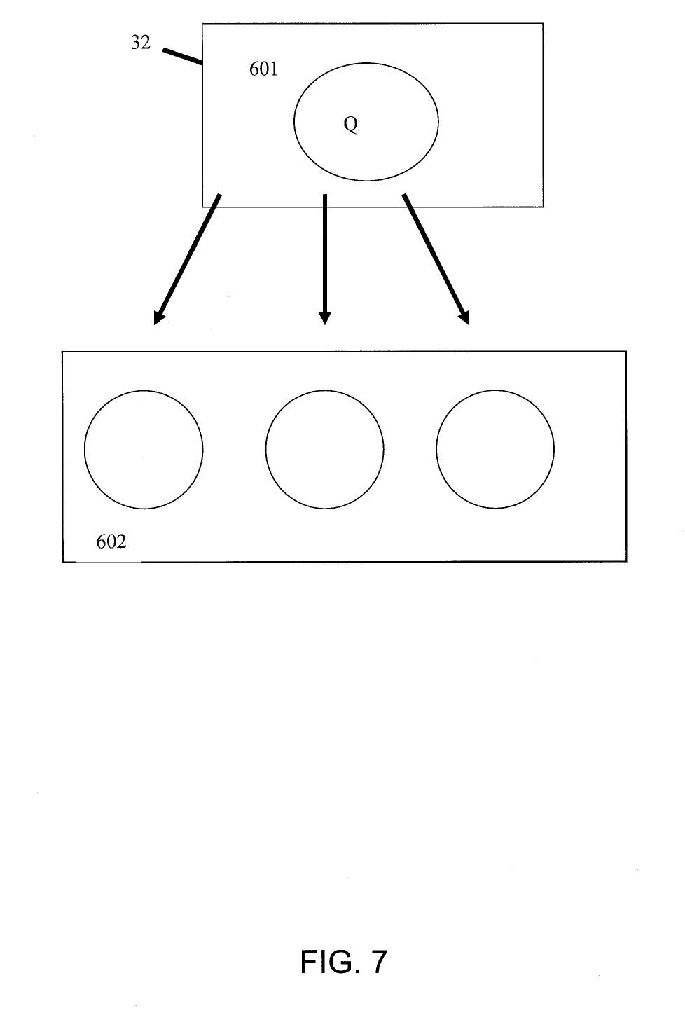

There are two ways to ask question. First is through the questioning and answering section 46 in a page. As shown in FIG. 7, while user 601 posts a question in a suitable page, user 602 reviews the page and finds the question. Then user 602 answers that question. If the answer is selected by user 601 as a good answer, in one embodiment, user 601 will automatically become user 602's follower.

In the second method, a user or a page could send Sweat to followers. Through this method, the user who renders question should have a reputation points above a predetermined value. Also through this method, the content of the question should be analyzed lexically. In one embodiment, after lexical analysis, system generates at least one tag to that question or the user rendering that question can provide tags on the question. In the case of a page or a user, the system would send notice to the page's followers or the user's follower for inquiry. Similar to one embodiment mentioned above, a user could select a Smart Route option. In the case when this option is selected, the system will perform a match process. The system would generate tags on each followers' Huka. For example, as the FIG. 7's example, the user 601 is the user 602's follower. The system will generate user 601's tags. The tag of user 601 is generated based on what user 601 had asked and had answered (the latter maybe more weighted). The tag of user 601 represents user 601's interests or knowledge range. The result of tagging is the tag shows which type of interests or knowledge belong to this participant based on participant's history record. Then system could match tags on the question and tags on each followers' Huka.

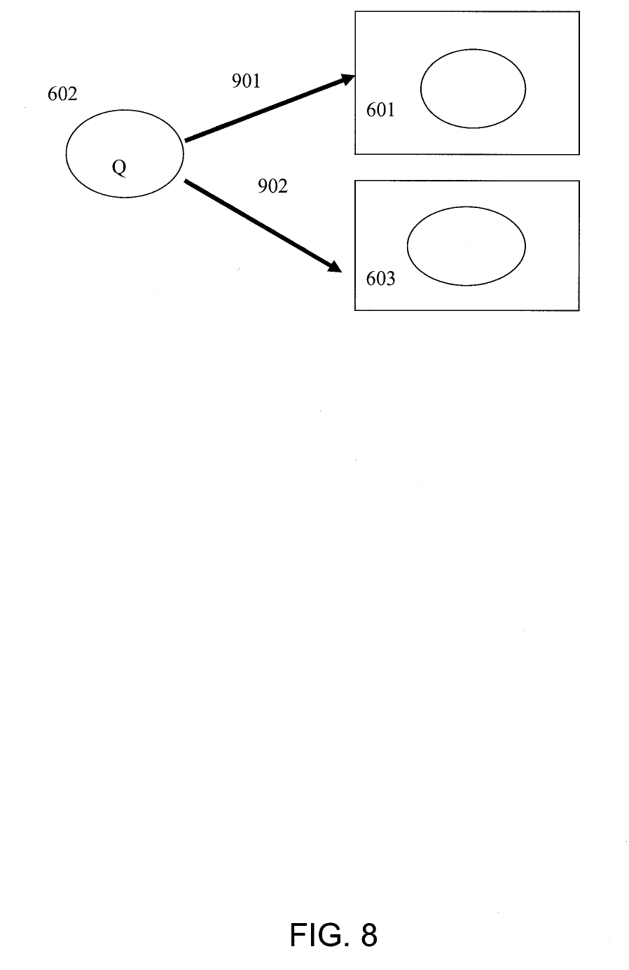

FIG. 8 shows an example when the Smart Route option is selected. When the matching process is done and a match degree is obtained, then manners in each route to send question or activation threshold level to send question is decided based on the match degree. The routes in the FIG. 8 contains a manner to send notice or activation threshold or other relevant parameters for sending notice, which is similar to send procedure in FIG. 5. The route 901 is utilized to send question to the group where followers have very relevant tags to the nature of the question. The route 902 is utilized to send to the group where the followers did not have any very relevant tag to the nature of the question. In this example user 603 contains no relevant tag associating the nature of the question user 602 asks. The routes 901 and 902 could be combined into one route (same result as Smart Route option is not selected) or each route could be divided into several small routes based on the relevancy levels or multi-factors.

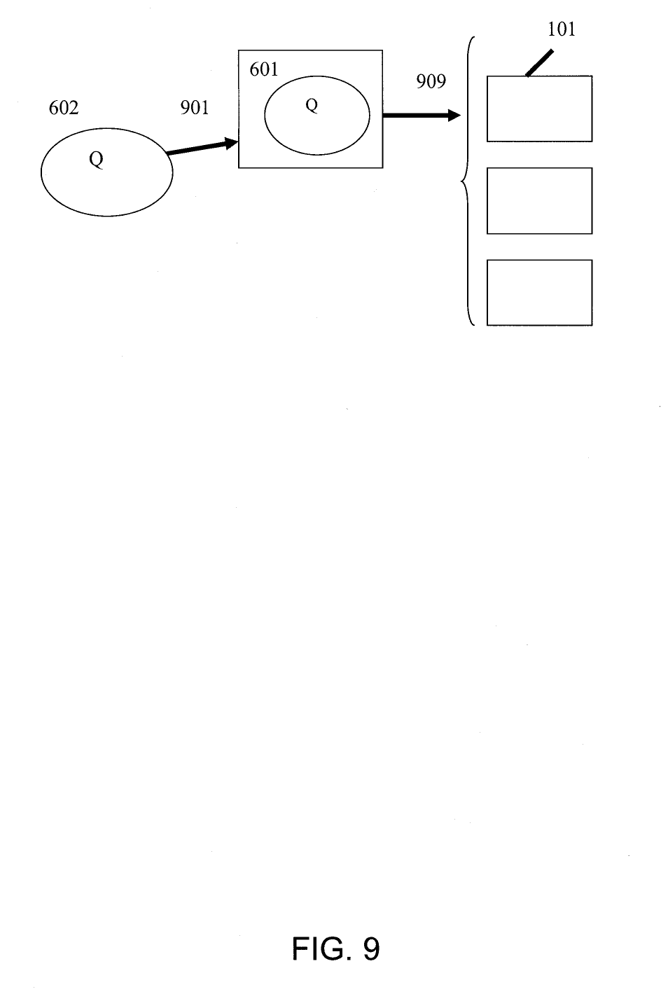

FIG. 9 shows a service function. User 602 asks a question through route 901. However no one answer or no answer user 602 feels satisfied. User 602 could post a help request in the comments and announcement area 48 or directly exchange credits with user 601 or with a user in the other group who is followed by a lot of people. If user 601 promises user 602, user 601 ask user's 602 question as its own question to user 601's followers 101 through route 909 or user 601 could obtain the answer by chatting in the online platform or by searching in the Internet. It is a kind of service user 601 provided and user 602 and user 601 can agree on credits would be exchanged. The online platform rewards credits to a user for contribution or cooperative works in the online platform. Besides, the online platform also contains a accumulated reputation points or data for a user to represent the trustworthy of the user participating in the online activities. In another word, by answering user 601's question, user 602 obtains one social capital—know who knows. By exchanging credit to service, user 602 knows who knows who knows.

When one asks question in the question and answer area 46 of the page 32, the answer to the question would be shown in the question and answer area 46 of the page 32. However if one request a help in the comments and announcement area 48 of the page 32, the recipient of answer, in one embodiment, could choose not to reveal the answer to the page 32.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of sending notice to a group of users in a cooperative online platform which has a page with a content area and a question and answer area, said method comprising:
(a) receiving a content;
(b) providing the content for reviewing in the content area of the page;
(c) obtaining a user input from a first user to indicate that the first user wants to receive a first notice of a new content in the page;
(d) sending the first notice to the first user;
(e) obtaining a user question by a second user, wherein the user question is designated by the second user to the page;
(f) providing the user question for reviewing in the question and answer area of the page;
(g) sending a second notice of the user question to the first user, and;
(h) obtaining a user answer from the first user in the page.

2. The method of claim 1, before sending the first notice to the first user, further include evaluating the new content based on a multifactor and obtaining a value after the evaluation.

3. The method of claim 2, wherein said sending the first notice to the first user is performed with a condition that the value is above a predetermined value.

4. The method of claim 3, wherein said sending the first notice to the first user is performed in a manner based on the value.

5. The method of claim 1, wherein said sending the second notice to the first user is performed with a condition that a reputation value of the second user is above a predetermined value.

6. The method of claim 5, wherein said page has a follower list comprises a list of a plurality of users want to receive the first notice of the new content in the page and before sending the second notice to the users, further include lexically analyzing content of the user question, tagging the users in the follower list of the page based on users' history record, based on lexically analyzing result and tagging result, generating a matching degree, and sending the second notice to the users in the follower list of the page in a manner according to the matching degree.

7. A method of sending notice in a cooperative online platform which has a page and a personal space, said method comprising:
(a) receiving a content of a first user in the page or in the personal space;
(b) providing the content in the page and in the personal space for reviewing;
(c) obtaining a user input from a second user to indicate that the second user wants to receive a first notice of a new content from the first user;
(d) sending the first notice to the second user if there is the new content from the first user in the page or in the personal space;
(e) obtaining a first user's question in the cooperative online platform by the first user, and;
(f) sending a second notice of the first user's question to the second user.

8. The method of claim 7, before sending the first notice to the second user, further include evaluating the new content based on a multifactor and obtaining a value after the evaluation.

9. The method of claim 8, wherein said sending the first notice to the second user is performed with a condition that the value is above a predetermined value.

10. The method of claim 9, wherein said sending the first notice to the second user is performed in a manner based on the value.

11. The method of claim 7, wherein said personal page has a follower list comprises a list of a plurality of users want to receive the first notice of the new content from the first user and before sending the second notice to the users, further include lexically analyzing content of the first user's question, tagging the users in the follower list based on users' history record, based on lexically analyzing result and tagging result, generating a matching degree, and sending the second notice to the users in the follower list in a manner according to the matching degree.

12. A method of sending notice to a group of users in a cooperative online platform which has a page with a content area and a help announcement area, said method comprising:
(a) receiving a content;
(b) providing the content for reviewing in the content area of the page;
(c) obtaining a user input from a first user to indicate that the first user wants to receive a first notice of a new content in the page;
(d) sending the first notice to the first user if there is the new content in the page;
(e) obtaining a user help announcement by a second user, wherein the user help announcement is designated by the second user to the page;
(f) providing the user help announcement for reviewing in the help announcement area of the page;
(g) sending a second notice of the user help announcement to the first user;
(h) obtaining a user answer from the first user, and;
(i) providing the second user the user answer based on a credit exchange between the first user and the second user.
